(19) United States
(12) Patent Application Publication
(10) Pub. No.: US 2025/0165455 A1
(43) Pub. Date: May 22, 2025

(54) PREDICTIVE CONCURRENCY CONTROL PROTOCOL AND SYSTEM THEREOF

(71) Applicant: Regatta Data Ltd., Bet Hanania (IL)

(72) Inventors: Erez WEBMAN, Petach Tikva (IL); Irit YADIN-LEMPEL, Caesarea (IL); Nitzan ZAMIR, Binyamina (IL); Roy Zeev GOLDSTEIN, Zikhron Ya'akov (IL)

(73) Assignee: Regatta Data Ltd., Bet Hanania (IL)

(21) Appl. No.: 18/944,462

(22) Filed: Nov. 12, 2024

Related U.S. Application Data
(60) Provisional application No. 63/600,145, filed on Nov. 17, 2023.

(51) Int. Cl. G06F 16/23

(52) U.S. Cl. CPC G06F 16/2336; G06F 16/2379

(57) ABSTRACT

A system and method of the device may include during a validation phase of a transaction, identifying conditional conflicts and their corresponding conflicting transactions, where the corresponding conflicting transactions are reading-transactions conflicting with the transaction. In addition, the device may include for each conditional conflict, classifying its state to determine if the transaction can commit, with respect to the conditional conflict, before the corresponding conflicting transaction. The device may include marking the transaction as dependent on the corresponding conflicting transaction when the transaction cannot commit before the corresponding conflicting transaction. Moreover, the device may include placing a commit pause on data cells modified by the transaction, thereby allowing the transaction to commit, when the transaction can commit before any corresponding conflicting transactions.

### CROSS-REFERENCE TO RELATED APPLICATIONS

This application claims the benefit of U.S. Provisional Application No. 63/600,145 filed on Nov. 17, 2023, the contents of which are hereby incorporated by reference. The subject matter of the present application relates to U.S. patent application Ser. No. 18/341,279 filed on Jun. 26, 2023. The contents of the Ser. No. 18/341,279 application are hereby incorporated by reference.

### TECHNICAL FIELD

The present disclosure generally relates to databases and, specifically, techniques for the implementation of a concurrency control protocol to maintain the serializability of concurrent operations in such databases.

### BACKGROUND

In databases, concurrency control protocols ensure correct results for concurrent operations are generated as quickly as possible. Typically, a concurrency control protocol provides rules and methods applied by the database mechanisms to maintain the consistency of transactions operating concurrently and, thus, the consistency and correctness of the whole database. Introducing concurrency control into a database would apply operation constraints which typically result in some performance reduction. Operation consistency and correctness should be achieved as efficiently as possible without reducing the database's performance. However, a concurrency control protocol can require significant additional complexity and overhead in a concurrent algorithm in comparison to a simple sequential algorithm.

A concurrency control protocol can be implemented in database management systems, transactional objects, and distributed applications. Such a protocol is designed to ensure that database transactions may be performed concurrently without violating the data integrity of the respective databases. Thus, concurrency control is an essential element for correctness in any database system where two database transactions or more, executed with time overlap, can access the same data, e.g., in virtually any general-purpose database system. There are different approaches to implementing a concurrency control protocol (or mechanism) in databases. The main approaches may be categorized as optimistic approaches and pessimistic approaches.

In some optimistic approaches, a check for whether a transaction meets the isolation and other integrity rules (e.g., serializability) is typically performed when the transaction ends, without blocking any of the transaction's operations. Other optimistic approaches check whether a transaction meets the isolation and other integrity rules (e.g., serializability), without blocking any of the transaction's operations. When the isolation of the transaction is violated, the transaction is aborted. An aborted transaction may be immediately restarted and re-executed, which incurs an overhead. As such, if too many transactions are aborted, the optimistic approach may be disadvantageous. In a pessimistic approach, an operation of a transaction is blocked when such an operation may cause a violation of consistency rules. In such cases, the operation is blocked until the possibility of violation of the transaction clears. The disadvantage of blocking operations involves performance reduction.

Different approaches for concurrency control in databases provide different levels of performance. The selection of the best-performing approach may be based on the type of transactions, the required performance, the type of databases, and the applications accessing the database. However, the selection and knowledge about trade-offs are not always available, and thus the implemented concurrency control approach may not be selected to provide the highest performance.

Further, some databases are designed where Atomicity, Consistency, Isolation, and Durability (ACID) requirements are relaxed. In such databases, as multiple transactions can execute concurrently and independently of each other, such transactions may overlap in their access to data. This could result in various inconsistencies. One method to ensure isolation between transactions and serialization in execution is by means of a well-designed concurrency control protocol.

Furthermore, existing concurrency control protocols are not efficient for transactions that include one or more predicates. Specifically, such protocols require placing locks or pausing the execution of transactions regardless of the states of the transactions' predicates. In databases, a predicate is a conditional (i.e., Boolean) expression that returns TRUE or FALSE. Predicates are commonly used in statements sent to databases and are often an inherent part of the database statement syntax or language. For example, a common usage of predicates would be to conditionally modify a data-cell(s) based on a condition that is based on data-cell(s). Another use of predicates in a relational database is when selecting one or more rows in a table. The selected rows are those for which the predicate evaluation, based on the contents of the row, returns TRUE. These selected rows can then be further acted upon.

It would, therefore, be advantageous to provide an improved concurrency control protocol for optimizing the performance of databases when executing transactions with predicates.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Some embodiments herein relate to a method. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

In one general aspect, the method may include during a validation phase of a transaction, identifying conditional conflicts and their corresponding conflicting transactions, where the corresponding conflicting transactions are reading-transactions conflicting with the transaction. Method may also include for each conditional conflict, classifying its state to determine if the transaction can commit, with respect to the conditional conflict, before the corresponding conflicting transaction. Method may furthermore include marking the transaction as dependent on the corresponding conflicting transaction when the transaction cannot commit before the corresponding conflicting transaction. Method may in addition include placing a commit pause on data cells modified by the transaction, thereby allowing the transaction to commit, when the transaction can commit before any corresponding conflicting transactions. Method may moreover include other embodiments of this aspect such as: corresponding computer systems, apparatus, and computer programs recorded on one or more computer storage devices, each configured to perform the actions of the methods.

In one general aspect, the method may include receiving at least one statement that is a part of a transaction, where the transaction is initiated by a client to be executed on a database system. Method may also include executing tasks included in each of the at least one received statements in an optimistic manner, where the received at least one statement is not a commit statement. Method may furthermore include upon receiving a commit statement, validating the transaction in a predictive and pessimistic manner to determine if the transaction can be committed before any conflicting transaction. Method may in addition include returning to the client an acknowledgement that the transaction is committed, where the transaction is not dependent on any conflicting transaction. Method may moreover include other embodiments of this aspect including corresponding computer systems, apparatus, and computer programs recorded on one or more computer storage devices, each configured to perform the actions of the methods.

In one general aspect, non-transitory computer-readable medium may include one or more instructions that, when executed by one or more processors of a device, cause the device to: during a validation phase of a transaction, identifying conditional conflicts and their corresponding conflicting transactions, where the corresponding conflicting transactions are reading-transactions conflicting with the transaction; for each conditional conflict, classify its state to determine if the transaction can commit, with respect to the conditional conflict before the corresponding conflicting transaction; mark the transaction as dependent on the corresponding conflicting transaction when the transaction cannot commit before any corresponding conflicting transactions; and place a commit pause on data cells modified by the transaction, thereby allowing the transaction to commit, when the transaction can commit before the corresponding conflicting transaction. Non-transitory computer-readable medium may also include other embodiments of this aspect including corresponding computer systems, apparatus, and computer programs recorded on one or more computer storage devices, each configured to perform the actions of the methods.

In one general aspect, the system may include one or more processors configured to. System may also include during a validation phase of a transaction, identifying conditional conflicts and their corresponding conflicting transactions, where the corresponding conflicting transactions are reading-transactions conflicting with the transaction. System may furthermore include for each conditional conflict, classify its state to determine if the transaction can commit, with respect to the conditional conflict, before the corresponding conflicting transaction. System may in addition include marking the transaction as dependent on the corresponding conflicting transaction when the transaction cannot commit before any corresponding conflicting transactions. System may moreover include placing a commit pause on a data cells modified by the transaction, thereby allowing the transaction to commit, when the transaction can commit before the corresponding conflicting transaction. System may also include other embodiments of this aspect including corresponding computer systems, apparatus, and computer programs recorded on one or more computer storage devices, each configured to perform the actions of the methods.

In one general aspect, the system may include one or more processors configured to. System may also include receiving at least one statement that is a part of a transaction, where the transaction is initiated by a client to be executed on a database system. System may furthermore include executing tasks included in each of the at least one received statements in an optimistic manner, where the received at least one statement is not a commit statement. System may in addition include upon receiving a commit statement, validate the transaction in a predictive and pessimistic manner to determine if the transaction can be committed before any conflicting transaction. System may moreover include returning to the client an acknowledgment that the transaction is committed, where the transaction is not dependent on any conflicting transaction. System may also include other embodiments of this aspect including corresponding computer systems, apparatus, and computer programs recorded on one or more computer storage devices, each configured to perform the actions of the methods.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an example network diagram of a distributed computing environment utilized to describe the various disclosed embodiments.

FIG. 2 shows an example diagram of a database arranged according to an embodiment.

FIG. 3 shows an example flowchart of a concurrency control protocol (CCP) executing transactions in the database.

FIG. 4 is a flowchart of an example process illustrating the operation of a validation phase of the predictive CCP according to one embodiment.

FIG. 5 is an example flowchart describing the process of classifying a conditional conflict as being in a stay-in state according to an embodiment.

FIG. 6 is an example flowchart describing the process of classifying a conditional conflict as being in a stay-out state according to an embodiment.

FIG. 7 is an example flowchart describing a process of classifying a conditional conflict as being in a move-in state according to an embodiment.

FIG. 8 is an example flowchart describing a process for classifying a conditional conflict as being in a move-out state according to an embodiment.

FIG. 9 is an example schematic diagram of a hardware layer of a node in a database according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, numerals refer to like parts through several views.

Some example embodiments provide a predictive concurrency control protocol implemented into a database system (or simply a database). According to the disclosed embodiments, consistency of transactions, by means of the disclosed protocol, is achieved through isolating transactions and adopting different approaches during the execution phases of a transaction. In an embodiment, an optimistic approach is implemented during the working phase of a transaction to allow the operation of multiple transactions to run independently without blocking or locks. For validation of a transaction, a pessimistic approach is taken, where a validating transaction may wait for other transaction(s) to commit, and where, under some circumstances, a transaction that evaluated predicates may not block other validating transaction(s) from committing. This is achieved by predicting the value of such predicates in a transaction being validated. As a result, significantly fewer transactions are aborted in comparison to a known implementation of an optimistic concurrency control protocol, thereby improving the overall performance of the databases. Further, significantly more transactions can be executed and committed in parallel than with a known implementation of an optimistic concurrency control protocol. Thus, the disclosed embodiments allow for higher parallelism in the transaction working phase, execution, and validation phases.

As such, the disclosed techniques allow for the fast execution of transactions and the processing of more transactions at a given time period. Therefore, the disclosed embodiments provide a technical improvement over current database systems that, in most cases, fail to serve applications that require fast and parallel execution of transactions for retrieval and modification of datasets. The disclosed embodiments can be implemented in database systems as well as in data management systems, such as an object storage system, a key-value storage system, a file system, and the like.

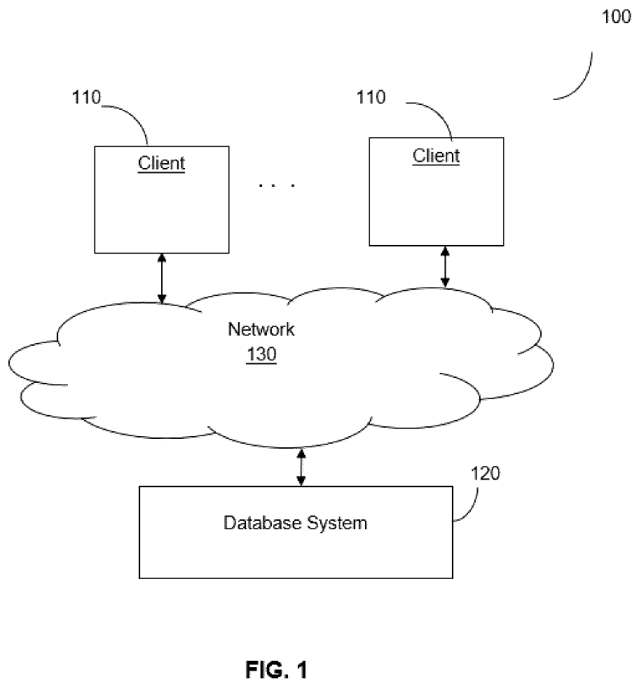

FIG. 1 shows an example network diagram 100 of a distributed computing environment utilized to describe the various disclosed embodiments. In the example network diagram 100, a plurality of clients 110 and a database system (or simply database) 120 are connected to a network 130. Database 120 can be either a distributed or non-distributed database. The network 130 may be but is not limited to, wireless, cellular, or wired network, a local area network (LAN), a wide area network (WAN), a metro area network (MAN), the Internet, the world wide web (WWW), similar networks, and any combination thereof.

Each client 110 is configured to access the database 120 through the execution of transactions. A client 110 may include any computing device executing applications, services, processes, and so on. A client 110 can run a virtual instance (e.g., a virtual machine, a software container, and the like).

In some configurations, clients 110 may be software entities that interact with the database 120. Clients 110 are typically located in compute nodes that are separate from the database 120 and communicate with the database 120 via an interconnect or over a network. In some configurations, an instance of a client 110 can reside in a node that is part of the database 120.

The database 120 may be designed according to a shared-nothing or a shared-everything architecture. The transactions to the database 120 are processed without locks placed on data entries in the database 120. This allows for fast processing retrieval and modifications of data sets.

A transaction is issued by a client 110, processed by the database 120, and the results are returned to the client 110. A transaction typically includes the execution of various data-related operations over the database system 120. These operations are often originated by clients 110. The execution of such operations may be short or lengthier. In many cases, operations are independent and unaware of each other's progress.

A transaction can be viewed as an algorithmic program logic that potentially involves reading and writing various data cells. A transaction, for example, may read some data cells through one data operation, and then, based on the values read, can decide to modify other data cells. That is, a transaction is not just an “I/O operation” but is more of a “true” computer program. A data cell is one cell of data. Data cells may be organized and stored in various formats and ways. Data cells, defined below, may be contained in files or other containers and can represent different types (integer, string, and so on).

An execution of a transaction may be shared between a client and the database 120. For instance, in an SQL-based relational database, a client 110 interacts with the database using SQL statements. A client 110 can begin a transaction by submitting an SQL statement. That SQL statement is executed by the database 120. Depending on the exact SQL statement, the database 120 performs various read and/or write operations as well as invokes algorithmic program logic typically to determine which (and whether) data cells are read and/or written. Once that SQL statement is completed, the transaction is generally still in progress. The client 110 receives the response for that SQL statement and potentially executes some algorithmic program logic (inside the client node) that may be based on the results of the previous SQL commands, and as a result of that additional program logic, may submit an additional SQL statement and so forth. At a certain point, and once the client 110 receives an SQL statement response, the client can instruct the database 120 to commit the transaction.

It should be noted that a client 110 can submit a transaction as a whole to the database 120, and/or submit multiple statements for the same transaction together, and/or submit a statement to the database 120 with an indication for the database to commit after the database 120 completes the execution of that statement.

It should be further noted that transactions may be abortable by the database 120 and/or a client 110. Often, aborting a transaction clears any of the transaction's activities.

For the sake of simplicity and ease of description, the following description would refer to a transaction initiated and committed by a client, and statements of the transaction are performed by the database 120. A transaction may include one or more statements. A statement may include, for example, an SQL statement. One of the statements may include a request to commit the transaction. To execute such a statement, the database may break the statement execution into one or more tasks, where each such task is running on a node. With this modeling, a task does not execute on more than a single node, but multiple tasks of the same statement can execute on the same node if needed. A task is an algorithmic process that may require the execution of read operation(s) and/or write operations(s) on data cells.

As defined herein without any limitation, a “writing-transaction” refers to a transaction that writes data cells. A writing-transaction may also read data cells. Note that any write-only transaction is also a writing-transaction, but the opposite is not correct. “Reading-transaction” refers to a transaction that reads data cells. A reading-transaction can also write data cells. It should be noted that any read-only transaction is also a reading-transaction, but the opposite is not correct.

As part of its execution, a statement may evaluate one or more predicates. A predicate is a conditional (i.e., Boolean) expression that returns TRUE or FALSE. Predicates are commonly used in statements sent to databases and are often an inherent part of the database statement syntax or language. For example, a common usage of predicates would be to conditionally modify a data-cell(s) based on a condition (predicate) that is based on data-cell(s).

As an example, consider the following data cells: john_hair_color. john_profession, john_salary, john_start_date; and the following a statement:
IF ((john_profession=software_engineer) AND (john_start_date<1.1.2010))
THEN
john_salary=john_salary*1.10
john_profession=senior_software_engineer

The predicate is the IF expression and can return TRUE if john is both a software engineer AND started to work earlier than 2010, or FALSE, otherwise. The conditional actions are setting john_profession to a senior software engineer and raising his salary by 10%.

A statement evaluating predicates may consider the value of “Predicate Data Cells” which are data cells that were used to calculate the predicate. In the above example, those are john_profession and john_start_date. Another way to term this would be that the predicate is evaluating a single Data-Cell Set, where that data-cell set is (john_profession, john_start_date).

In databases, a statement can be executed on a single, specific row, where that statement involves a predicate (or multiple predicates), where each predicate evaluates a single data-cell set that is often associated with that row.

In addition, in relational databases, as well as in some non-relational databases, it is also possible to perform a statement on a set of rows where the specific identity of the rows is not explicitly known. Instead, the rows are selected according to various criteria and are often selected by a predicate.

For example, in a relational database with an employee table (a row represents each employee), the following SQL statement is performed: “For all the employees that have a profession of software_engineer and started to work in the company earlier than 2010, modify their profession to senior_software_engineer and raise their salary by 10%”. It should be noted that the SQL statements provided herein are not in their proper SQL syntax.

In that case, the scope of the statement is the entire table, and so is the scope of the predicate. While the predicate data cells are actually the entire profession and start_date columns (i.e., all the corresponding cells for all the rows in the table), the predicate operates, each time, on a separate data-cell set. Such a data-cell set would be, for example, the cells: John's profession and John's start_date. The predicate will also operate on Betty's profession and Betty's start_date (yet another relevant data-cell set). However, inherently, according to the statement semantics, the predicate will not operate on John's profession together with Betty's start_date.

A transaction may be executed over the database 120 in three phases: working, validation, and commit. In some configurations, a transaction may be executed over the database 120 in two phases: working and commit. The embodiments carried by the disclosed concurrency control protocol in each phase are discussed in great detail below.

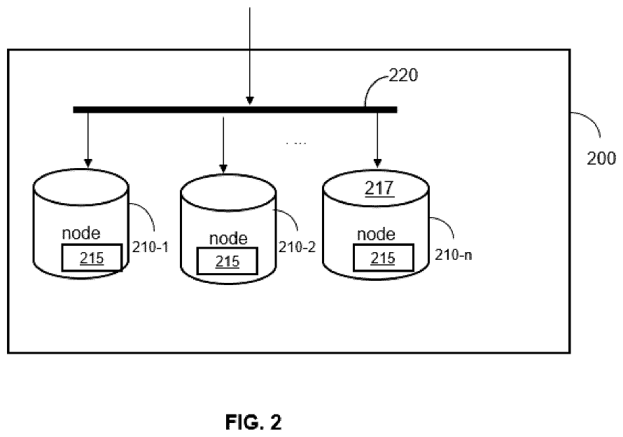

In an embodiment, the database 120 is a distributed database and may be realized as a relational database system (RDBMS) or a non-relational database. As will be demonstrated in FIG. 2 below, a distributed database is a configuration of multiple computers (hereinafter nodes) that may be situated in the same physical location or in multiple locations. Such locations are typically not geographically distributed. The distribution arrangement of the database 120 requires the execution of transactions and their operations on different nodes independent of each other. Typically, a node is a computer, however, it can also be a virtual server, a user-mode process, a combination thereof, and the like.

In another embodiment, the database 120 is a non-distributed database and may be realized as a relational database system (RDBMS) or a non-relational database. A non-distributed database is a configuration of one node that may be situated in one physical location. Also, in a non-distributed database, a node is generally a computer. However, it can also be a virtual server, a user-mode process, a combination thereof, or the like.

FIG. 2 shows an example diagram 200 of database 120 arranged according to an embodiment. The database 120 includes a plurality of nodes 210-1 through 210-n, which are distributed. In some configurations, the database 120 operates with one node as a non-distributed arrangement. Each node 210 may be realized as a physical device or a virtual instance executed on a physical device. A virtual device may include a virtual machine, a software container, a service, and the like. The physical device, an example of which is disclosed below, includes at least a processing circuitry and a memory. A physical device may also include a storage, a shared storage accessed by other nodes 210, or a combination thereof. The storage stores the data maintained by the database 120. The nodes 210 may be deployed in one or more data centers, cloud computing platforms, and the like. The communication and synchronization among the nodes 210 are performed through an interconnect network 220.

In one embodiment, the nodes 210, and hence the database 120 are designed with a shared-nothing architecture. In such an architecture, nodes 210 are independent and self-sufficient as they have their own disk space and memory. As such, in the database 120, the data is split into smaller sets distributed across the nodes 210. In another embodiment, the nodes 210, and hence the database 120 are designed with a shared-everything architecture where the storage is shared among all nodes 210.

The data managed by the database can be viewed as a set of data cells. While the most natural form of those data cells would be items, such as what relational databases refer to as “column cells”, those data cells can actually be any type of data, data object, file, and the like.

Databases often organize a higher level of a data object referred to as data row (or simply row). A data row may include a collection of specific data cells. For example, in relational databases, a set of rows form a database table. The data cells contained by a specific row are often related to one “entity” that the row describes. In relational databases, the concept of a data row is inherent to the data model (i.e., one of the foundations of the relational data model is processing “data tuples” that are effectively data rows). Often, data cells can be added or removed only as part of their data row. In other words, a data row can be added (or removed), thus adding more (or removing existing) data cells to the database.

Typically, all the data cells of a specific row reside in close proximity (e.g., consecutively) on the storage device, as this can ensure that multiple cells of the same row (or all the cells of the row) can be read from the disk more cheaply (e.g., with a single small disk I/O) than if those cells would each be stored elsewhere on the disk (e.g., with n disk I/Os to n different disk locations in order to retrieve n cells of the same row). Further, the metadata for managing the data cell information may also be organized in a rougher resolution as it may result in meaningfully lesser and smaller overall metadata.

In some embodiments, a specific data row can be viewed as if it exists and just contains a single specific data cell. In one configuration, and without limiting the scope of the disclosed embodiments, a single cell, and a single row may reside in a specific storage device of a node 210. However, it should be noted that a row can be divided across multiple nodes. It should be further noted that the disclosed embodiments can be adapted to operate in databases where data cells are stored and arranged in different structures. In some embodiments, where a row is divided across multiple nodes, the “sub row” that is stored under a single node and/or storage device could be treated as a data row.

In another embodiment, and without limiting the scope of the disclosed embodiments, the database may also store various pieces of data, in addition to the data cells, and data rows, including, but not limited to, any and all metadata, various data structures, configuration information, a combination thereof, and the like (hereinafter “metadata”).

In some embodiments, an operation of a task may access a single data cell in a single node 210. Furthermore, multiple operations (of the same or different transactions) may access the same data cells simultaneously or substantially at the same time. There is no synchronization when such operations, tasks, or statements of a transaction or transactions are performed. In a typical computing environment, hundreds of concurrent transactions can access the database 120. As such, maintaining and controlling the consistency of transactions and their operations is a critical issue to resolve in databases.

In an embodiment, each node 210 includes an agent 215 configured to manage access to data stored on the respective node. The agent 215 may be realized in hardware, software, firmware, or a combination thereof. Software shall be construed broadly to mean any type of instructions, whether referred to as software, firmware, middleware, microcode, hardware description language, or otherwise. Instructions may include code (e.g., in source code format, binary code format, executable code format, or any other suitable format of code).

The agent 215 is configured to manage the contents of data cells and operations within a node. For example, when a write operation requires access to data cell(s), the agent 215 may be configured to point to the requested cell(s). In an embodiment, each transaction is managed by a transaction manager 217. A transaction manager 217 is an instance executed over one of the nodes 210 and configured to orchestrate the execution of a transaction across one or more nodes 210. The transaction manager 217 may be instantiated on any node 210. In the example shown in FIG. 2, transaction manager 217 runs on the node 210-n. The transaction manager 217 can be realized as a software object, a script, and the like executed over the hardware of a respective node 210. It should be noted that multiple transaction managers may be executed on one node or multiple nodes, where each transaction manager handles a single transaction.

It should be noted that the transaction managers 217 and agents 215 are logical entities that may reside on different nodes, and allow to manage the execution of transactions across multiple nodes. In configurations where the database 120 is a non-distributed database, the transaction manager and agent can be a single logical entity or operate as two different entities (on the same node). An example of the arrangement of a non-distributed database and example embodiments for running a CCP on such a database can be found in U.S. patent application Ser. No. 18/591,615, filed on Feb. 29, 2024, and incorporated herein by reference.

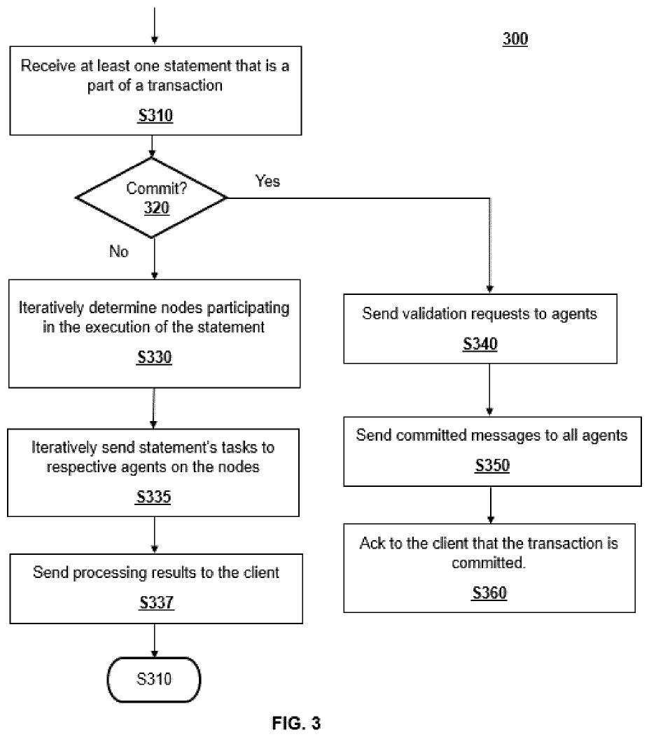

FIG. 3 shows an example flowchart 300 of a concurrency control protocol (CCP) executing transactions in the database 120. The method can be performed by a transaction manager instantiated on one of the nodes, such nodes as 210, FIG. 2.

At S310, at least one statement that is part of a transaction initiated by a client is received. A transaction may include a collection of statements, each of which may include a collection of tasks. A task may require the execution of read operation(s), write operation(s), or both. A task may be a program or logic typically executed by an agent. A read operation requires reading data from a data cell, while a write operation requires writing data to a data cell. A statement may include a commit statement, thereby committing the transaction.

At S320, it is checked if a received statement is a commit statement, and if so execution continues with S340; otherwise, execution continues with S330.

At S330, nodes (210, FIG. 2) participating in the execution of tasks associated with the received statements are determined. There are different techniques to determine such nodes. For example, a node can be determined based on an index pointing to where data cells to be accessed are located. The techniques to determine nodes of such that are outside of the scope of the disclosed embodiments.

At S335, the tasks are sent to determined nodes. Such nodes process the tasks that are part of a received statement. In an embodiment, a list of the determined agents participating in the working phase of the statement is maintained. Further, for each such agent, it is determined if the agent performs at least one write operation, during the entire execution of a transaction. The execution of such operations by an agent (215) during a working phase is discussed in greater detail below. It should be noted that S330 and S335 may be performed iteratively as part of the execution of one task when it is determined that another task is required. It should be further noted that S330 and S335 may be performed in parallel or, at certain times, in a different order. If the database system is configured as a non-distributed database, S330 and S335 are performed on the same node.

At S337, at the end of the execution of all tasks associated with the received statement, a response is sent back to the client with the results of the processing of the statement. Then, execution returns to S310.

Execution reaches S340, when a commit statement is received from the client. At this stage, a validation request is sent to every agent that performed a write operation during the execution of the received transaction. In the CCP, each agent performing a validation will take a commit pause at the end of the validation process. The commit pause is taken to enable the atomicity of the distributed transaction commitment, by preventing race conditions between the committing transaction that completed its validation and other transactions that may then attempt to read data cells that were modified by the committing transaction.

At S350, upon receiving validation confirmation messages from agents (or an agent in a non-distributed configuration) that performed write operations, committed messages are sent to all agents that participated in the execution of the transactions. It should be noted that the committed messages are sent to all agents participating in the execution of the statement regardless of if such agents performed write operations, or not. A committed message indicates to the agent to commit the operations performed and to release the commit pause taken during the validation phase. At S360, an acknowledgment is sent to the client that the transaction is committed. It should be noted that S350 and S360 can be performed in parallel or in a different order.

As can be understood from the above description, the operation of a transaction manager carries through three phases: working, validation, and commit. In the working phase, one or more statements of a transaction are processed. In the validation phase, all data cells that have been written through the transaction are validated. In the commit phase, the entire transaction is committed.

The method discussed with reference to FIG. 3 provides CCP implemented into a database system (or simply a database). Consistency of transactions, by means of the disclosed protocol, is achieved through isolating transactions and adopting different approaches during the execution phases of a transaction. Here, an optimistic approach is implemented during the working phase of a transaction to allow the operation of multiple transactions to run independently without blocking or locks. For validation of a transaction, a pessimistic approach is taken, where a transaction may wait for other transaction(s) to commit. As a result, fewer transactions are aborted in comparison to a known implementation of an optimistic concurrency control protocol, thereby improving the overall performance of the databases. The detailed operation of the CCP as discussed in FIG. 3 includes the working-phase, validation-phase, and commit-phase are described in greater detail in the above-referenced Ser. No. 18/341,279 application.

The disclosed embodiments provide a predictive CCP, which allows, in some cases, the early commit of validating transactions. That is, in some cases, a validating writing transaction TR1 may progress to commitment even when it modified a data cell, or multiple data cells that were read by a reading transaction TR101 that has not yet been committed.

According to the disclosed embodiments, same as the CCP discussed in FIG. 3, the working phase of the predictive CCP is non-blocking. This is advantageous as locking mechanisms tend to result in slower speeds, greater expenses, and greater complexity.

In general, optimistic CCP approaches are non-blocking, but tend to abort transactions upon the detection of conflicts, and usually require the detection of read/write, write/write, and write/read conflicts. As opposed to conventional optimistic CCP approaches, the disclosed embodiments are more tolerant, as the predictive CCP requires only the detection of read/write conflicts. Further, the predictive CCP allows, in some cases, ignoring read or write conflicts that cannot be ignored by conventional optimistic CCP approaches.

Furthermore, according to the disclosed predictive CCP, even if the read/write conflict cannot be ignored, transactions that participate in such a conflict will generally not abort. Instead, in the disclosed protocol, dependencies among such transactions will alter the order of commitments. Any such blocking during validation-phase is done only after the validating transaction has already completed its working-phase and thereby released the resources that were required for its execution. In that respect, such a blocking would use meaningfully fewer resources than a blocking by a conventional CCP. Furthermore, in distributed database environments, the realization of these dependencies is generally simple and consumes minimal resources.

It should be noted that as would also apply to conventional pessimistic and optimistic CCPs, the predictive CCP is not immune from inter-transaction deadlocks. In the case where an inter-transaction deadlock is detected, one transaction out of the deadlock cycle would be aborted. Techniques for handling deadlocks, including deadlock detection and deadlock prevention techniques, are beyond the scope of the present disclosure.

It should be further noted that the disclosed predictive CCP allows for the performance of a higher degree of parallelism in transaction execution relative to pessimistic solutions while maintaining the same state of the database at the end of processing such transactions as if the transactions were executed in serial. This allows for the fast execution of transactions and the processing of more transactions at a given time period. Therefore, the disclosed embodiments provide a technical improvement over current database systems that, in most cases, fail to serve applications that require fast and parallel execution of transactions for retrieval and modification of datasets. The disclosed predictive CCP can be implemented in database systems as well as in data management systems, such as an object storage system, a key-value storage system, a file system, and the like.

As briefly mentioned above, in the predictive CCP, in some cases, a validating writing transaction (i.e., a transaction that is in a validation-phase), hereby referred to as TR1, that has modified a data cell (or a set of data cells) previously read by an existing reading transaction, hereby referred to as TR101, may be enabled to commit even prior to the completion of TR101. This enablement improves the concurrency of the transaction execution. In contrast, it should be noted that in some CCPs disclosed in the related art, transaction TR1 would always be dependent on TR101's completion and would not be able to commit prior to the completion of TR101.

It should be noted that the above-mentioned cases that allow such an earlier commitment have to do with cases where TR101 evaluated a predicate as part of its execution. As mentioned above, a predicate, as discussed in the related art, may be defined as a part of a transaction statement within a database that describes a condition upon which an action may commence. As a non-limiting example, a transaction enacted on a single row in a database may be colloquially described as the following directive: “If John's profession is ‘software engineer’ and John's start date is before Jan. 1, 2010, then increase John's salary by ten percent and update John's profession to senior software engineer”. For such a transaction, the predicates are the variables included in the “if” clause, namely “John's profession” and “John's start date”. In contrast, the actions are the steps taken in the “then” clause, namely the increase in John's salary and the update to John's profession.

It should be noted that, as previously discussed, predicates can also be used as part of a statement that selects one or multiple rows that satisfy a predicate. For example, in such a statement where the predicate data cells are “profession” and “start date”, the predicate data-cell set may comprise “[Jane's profession, Jane's start_date]”, “[John's profession, John's start_date]”, and so on.

In an embodiment, TR101 may have read a relevant data-cell set as part of a predicate evaluation, where, after the predicate returned TRUE or FALSE, the actual concrete contents of the read data cells that were used for the predicate evaluation are not further used by TR101. In such cases, if a writing-transaction TR1 modifies one or more of those predicate data cells in a way that will not affect the result of the predicate, then, with some further conditions fulfilled, TR1 may consider itself not dependent on that specific TR101's predicate evaluation (and its associated reads). In this specific example, if no other dependencies of TR1 on TR101 are detected, TR1 may commit before TR101's commitment, i.e., TR1 is not dependent on TR101.

It should be noted that the improvement in commitment efficiency described above can be meaningfully beneficial. For example, in relational databases as well as other databases, there are direct ways to access specific cells of specific rows (e.g., by specifying a row ID, a primary index, etc.). However, there are (for example) SQL statements with a broader scope where such a statement acts upon a set of row(s) that are selected by evaluating a predicate. The table rows that satisfy the predicate are the ones that are affected by the statement. The predicate evaluation is either done by a full (data) scan, by index searches, or by a combination of index searches and data scans.

From a general serializable CCP perspective (i.e., without the mechanisms described by this disclosure), such a predicate-based search (e.g., performed by a reading transaction TR101) is generally analogous to reading all the predicate data cells of all the rows in the table (e.g., of the entire columns related to the predicate), even if only some or even very few of the rows answer the predicate and are actually used by TR101. That may meaningfully limit the concurrency in transaction execution, as it may create many conflicts with other transactions. For example, a writing transaction TR1 that modified pertinent data cells in a couple of rows that were not selected by TR101 may, in many cases, be blocked due to TR101, despite the fact that TR101 did not select these couple of rows. Therefore, the disclosed embodiments provide mechanisms that minimize such dependencies whenever possible.

The following discussion covers the different forms of the described predictive CCP. It is important to note that the examples used are for instructional purposes only.

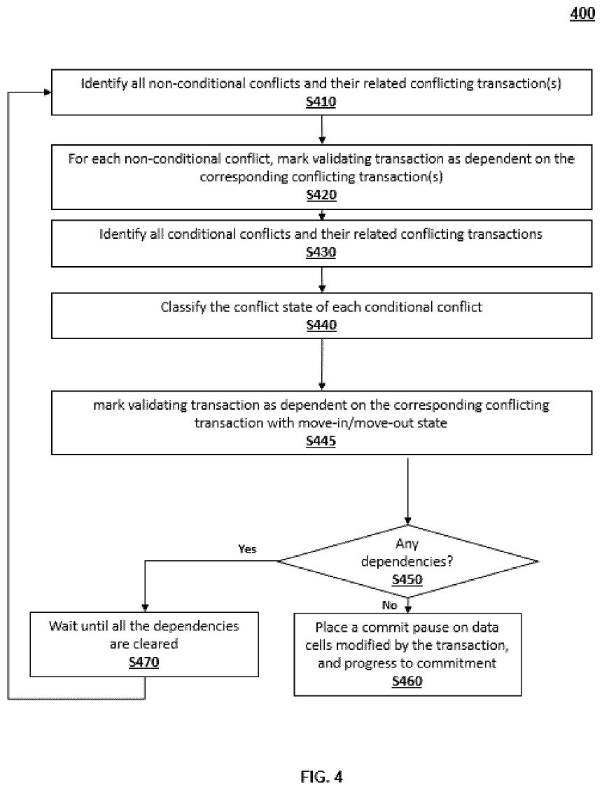

FIG. 4 is a flowchart of an example process 400 illustrating the operation of a validation-phase of the predictive CCP according to one embodiment. The process 400 can be performed by each of the validating transaction's (TR1) transaction agents instantiated on the nodes, such as nodes 210 in FIG. 2. The method is performed during the validation-phase of transaction TR1 to check what dependencies the validating transaction (TR1) has on other existing reading-transactions. The method further inspects whether the validating transaction (TR1) can be enabled for an early commit over a reading transaction (TR101) that evaluates one or more predicates that use data cells that TR1 modified.

FIG. 4 describes some aspects of the validation-phase performed during predictive CCP. The working-phase and the commit-phase of the predictive CCP can be performed as discussed in reference to FIG. 3. A validation-phase is a process within a transaction, for example, TR1, whereby TR1 checks for whether another existing reading transaction has read any of the data cells that were modified by TR1. A validation phase may occur after a working phase and may result in a block of TR1 until the commitment of a reading transaction, for example, TR101, on which TR1 is determined to be dependent. According to the disclosed embodiments, the validation phase may not always determine that TR1 depends on TR101, which had read data cells that TR1 modified, and hence, in some cases, the validation phase may allow TR1 to commit before TR101 has committed.

Typically, the method described by FIG. 4 is performed when a commit statement is received from the client. At this stage, a validation request is sent to every agent that has performed a write operation.

It should be noted that according to the disclosed embodiments, before or during a working-phase of a transaction (TR5), a read-vector (RV) and a write-vector (WV) are created. During a working-phase of the transaction TR5, when TR5 reads a data cell that is not for the purpose of a predicate evaluation, the transaction (TR5) may add an RV-entry to its RV, designating the data cell being read, and may then read the most up-to-date committed cell contents.

This type of an RV-entry may be denoted as a “non-conditional RV-entry”, and this type of reading may be denoted as a “non-conditional read”. In an embodiment, during a working-phase of TR5, when TR5 evaluates a predicate, the transaction (TR5) may add an RV-entry to its RV, designating the entire predicate evaluation. This type of an RV-entry may be denoted as a “conditional RV-entry”. A conditional RV-entry contains information describing the predicate that is evaluated. A single conditional RV-entry may represent a predicate evaluation of a single data-cell set or of multiple data-cell sets, where the latter is typical, for example, for cases where the scope of the predicate contains multiple rows or the entire set of rows of a table.

Then, transaction TR5 may perform the predicate evaluation of one or more data-cell sets by reading their most up-to-date committed cell contents. Such data-cell read(s) may be denoted as a “conditional read”. During a working-phase of the transaction TR5, when TR5 writes a data cell, it may add a WV-entry to its WV, designating the data cells being written. Additionally, transaction TR5 may write the data-cell contents in an “uncommitted manner” such that they are “private” and hence inaccessible for reading by any other transaction. Such a data-cell write may not override or change any elements of the currently committed data-cell contents.

At S410, the current non-conditional conflicts between a reading transaction and the validating transaction are identified. In general, a conflict may be indicated by the presence of cells that were modified by a validating transaction, such as TR1, and were read by another existing reading transaction, such as TR101. A non-conditional conflict may be defined as a conflict pertaining to a read operation by the reading-transaction (TR101) that was not performed as part of a predicate evaluation. In an embodiment, all the current non-conditional conflicts with the validating transaction are identified. Such a reading-transaction may be denoted as a “conflicting transaction”. In one example embodiment, S410 includes iteratively scanning the write vector of the validating transaction TR1 for data cells that TR1 wrote to. Further, for each such data cell, all active reading transactions (except for TR1 itself) that read from the cell are identified. This can be performed by scanning the reading transactions' read vectors. The read and write vectors are maintained by each agent (e.g., agent 215 according to FIG. 2).

At S420, the validating-transaction is marked as dependent on each of the identified conflicting transactions. The dependencies can be maintained in a data structure, such as a graph, a tree, a table, and the like. It should be noted that if no non-conditional conflicts are identified, S420 is skipped.

At S430, current conditional conflicts and their related conflicting transactions are identified. A conditional conflict may be defined as a conflict pertaining to a read by the reading-transaction (TR101) that was performed as part of and for the purpose of predicate evaluation of a specific data-cell set. In an embodiment, all the current non-conditional conflicts with the validating transaction are identified. A read that was performed as part of and for the purpose of a predicate evaluation may be denoted as a conditional read and may include the creation of a conditional RV-entry. Such a reading-transaction may also be denoted as a “conflicting transaction”. In an embodiment, a conditional RV-entry represents the entire predicate evaluation.

It should be noted that a conditional conflict is in a data-cell set granularity. In an example embodiment, a reading-transaction TR101 evaluates a predicate PR1010 for all the rows in a table. The predicate PR1010 is used to select the rows of people with “red” hair color and a profession of “software engineer”. In this example, the validating transaction (TR1) modified Jane's hair color and modified George's hair color.

In this example, there are two conditional conflicts between TR1 and TR101, both for predicate PR1010. That is, one conditional conflict is for the data-cell set [Jane's hair color, Jane's profession], and the other conditional conflict is for the data-cell set [George's hair color, George's profession].

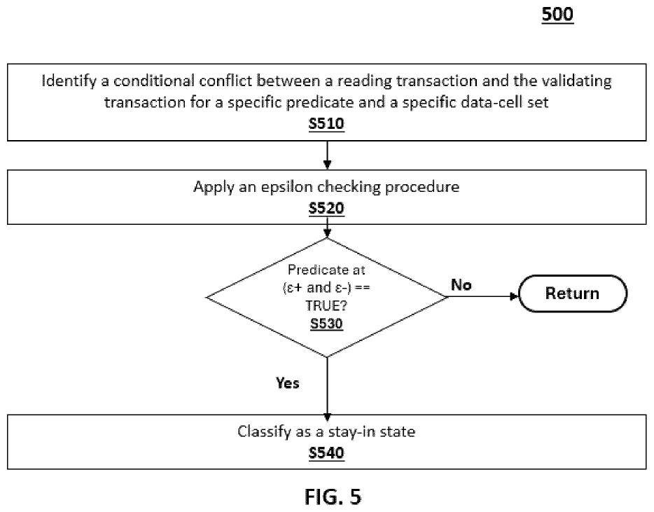

At S440, a conditional conflict is classified as being of a particular state. A state characterizes a particular relationship between the evaluations of a predicate before and after the commitment of a validating transaction TR1. The process of determining the state of the conditional conflict is discussed further below. In an embodiment, the state may be one of the following: stay-in, stay-out, move-in, and move-out. In an embodiment, the determination of each of the four states requires the execution of the epsilon checking procedure as further described by FIGS. 5-8 and discussed below. It should be noted that there is no need to run all procedures discussed in FIGS. 5-8 to determine the state of the conditional conflict. The classification of a conditional conflict is based on an evaluation of its respective predicates. The evaluation of a predicate may result in a Boolean value, TRUE and FALSE.

At S445, the validating transaction TR1 is marked as dependent on reading transactions that have conditional conflicts with the validating transaction TR1 that are classified as move-in and move-out. Such transactions may be referred to as conflicting transactions. It should be noted that if a validating transaction TR1 has multiple conditional conflicts with reading transaction TR101 and one or more of those conditional conflicts are classified as move-in or move-out, then the validating transaction TR1 is marked as dependent on the reading transaction TR101. The dependencies can be maintained in a data structure, such as a graph, a tree, a table, and the like. It should be noted that if no conditional conflicts have been classified as move-in or move-out, S445 is skipped.

At S450, it is checked if any dependencies were marked in S420, S445, or both. If so, execution proceeds with S470. Otherwise, a commit pause is placed on data cells modified by the validating transaction (S460). Placing the commit pause allows the validating transaction to progress to the commit stage.

At S470, the validating transaction waits until all dependencies are cleared. Then, execution returns to S410. It should be noted that returning to S410 is required as additional conflicts may have been added, for example, during the execution of S470.

It should be noted that in an embodiment, the commitment process for the validating transaction may be paused for as long as the reading transactions it depends on have not completed their execution, that is until those reading transactions commit or abort. For example, the determination that a conditional conflict is in a move-in state will lead to a dependency of the validating transaction on the corresponding reading transaction. This pause is initiated in order to preserve concurrency control and prevent the committed values of the validating transaction from compromising data integrity.

As discussed above, the procedure described above inspects whether the validating transaction (TR1) can be enabled for an early commit over a reading transaction (TR101) that evaluated one or more predicates that use data cells that TR1 modified. It should be further noted that in order for the early commitment of the validation transaction to satisfy concurrency control requirements, the evaluation of the predicate of a reading transaction TR101 should follow a set of conditions. The set of conditions may be denoted as the single predicate evaluation consistency principle. As already discussed, when a predicate is evaluated as part of a statement execution, it is evaluated for one or more data-cell sets, where each data-cell set may contain one or more data cells. The following conditions hold for each predicate evaluation of a specific data-cell set separately. A first condition is that, for each such predicate evaluation of a single data-cell set, the contents of all the corresponding data-cell reads (for that specific data-cell set) should belong to the same set of database data cells as the set that exists at a single specific point in time that is denoted as the virtual read timepoint. That is, if, for example, a predicate data-cell set contains two data cells, [Jane's profession and Jane's hair color], then the read contents of the two data cells must be the committed contents of those data cells for the very same point in time, namely the virtual read timepoint. However, it should be noted that if the predicate evaluates multiple data-cell sets, then the virtual read timepoint of each data-cell set may be different. A second condition is that the virtual read timepoint must be a later time than the time the conditional RV-entry was added to a reading transaction's RV. That also means that the reading transaction TR101 should add the corresponding conditional RV-entry to its read-vector before it performs any related reads that are required for the predicate evaluation. A third condition is that the virtual read timepoint must be an earlier time than the time of usage of the predicate evaluation results.

Although FIG. 4 shows example blocks of process 400, in some implementations, process 400 may include additional blocks, fewer blocks, different blocks, or differently arranged blocks than those depicted in FIG. 4. It should be noted that, in an embodiment, standard means of avoiding race-conditions among validating transactions are assumed. In an example embodiment, blocks S410 to S460 are performed atomically, such that multiple validations cannot occur concurrently, and new conflicts cannot occur during those blocks' execution.

It should be noted that in an embodiment, a method of detecting whether a conditional conflict results in a dependence may utilize an epsilon checking procedure (based on the epsilon principle). That is, given a validating transaction TR1 that has a conditional conflict with a reading transaction TR101, the procedure allows determining the state of the conditional conflict, that is, whether it is in a stay-in, stay-out, move-in, or move-out state. The epsilon checking procedure relates to two methods of characterizing the moments immediately before and immediately after a transaction commitment. For example, for a validating transaction TR1 that modifies the cell contents corresponding to an employee's hair color from “black” to “red”, at the moment immediately before TR1's commitment, the employee's hair color will be “black”, and at the moment immediately after TR1's commitment, the employee's hair color will be “red”. The function ε−(TR1) may be denoted to describe the moment immediately prior to the commitment of transaction TR1, while the function ε+(TR1) may be denoted to describe the moment immediately following the commitment of transaction TR1.

In an embodiment, by way of the epsilon checking procedure, an evaluation of a predicate of a transaction may be denoted in relation to a specific timepoint for a specific row. For example, for a predicate PR1010, a function PR1010(x, ε+(TR1)) will return the evaluation of PR1010 for the pertinent data-cell set of row ‘x’ at the moment immediately following the commitment of a transaction TR1. According to an example embodiment where a transaction TR1 is initiated after a transaction TR101 is initiated and before TR101 is committed, TR101 involves the evaluation of a predicate PR1010, and TR1 is validating, the epsilon principle allows for TR1 to commit before the commitment of TR101 if PR1010(x, ε+(TR1))=PR1010(x, ε−(TR1)). That is, if the evaluation of PR1010 at row x returns the same values immediately prior to TR1's commitment as immediately following TR1's commitment, TR1 may be allowed to commit before the commitment of TR101. This case may be denoted as an expression that the “epsilon principle is satisfied”. It should be noted that in a plurality of embodiments, there may be more than one predicate that would need to satisfy the epsilon principle in order to allow for TR1 to commit early.

It should also be noted that an evaluation and satisfaction of the epsilon principle effectively checks for what may be denoted as stay-in or stay-out states, which are discussed further below. It should also be noted that if the epsilon checking procedure (using the epsilon principle) is not satisfied for a validating transaction TR1 in relation to a reading transaction TR101, it may then be necessary to create a dependency of TR1 on TR101 such that TR1 would be unable to commit until after the commitment of TR101.

FIG. 5 is an example flowchart describing process 500 of classifying a conditional conflict as being in a stay-in state according to an embodiment. Process 500 may be performed as part of S440 described in FIG. 4.

At S510, a conditional conflict for a specific predicate and a specific data-cell set that the reading-transaction evaluated is identified. The conditional conflict is between a validating transaction and a reading-transaction, and the specific data-cell set includes, for example, the relevant data-cells for the predicate evaluation in a specific row. According to an example embodiment, the validating transaction may be denoted as TR1, the reading-transaction containing the predicate to be evaluated may be denoted as TR101, and the defined predicate may be denoted as PR1010. Additionally, according to the example embodiment, the predicate evaluates multiple rows of a table, so the identity of a row (e.g., row x) will be used to denote the associated data-cell set. It should be noted that according to the example embodiment, TR1 and TR101 run concurrently.

At S520, an epsilon checking procedure is applied to the identified conditional conflict. According to an embodiment, the epsilon checking procedure applies the epsilon principle to the predicate PR1010 and a specific data-cell set. According to the example embodiment, the evaluation of PR1010(x, ε+(TR1)) may return a value of “TRUE,” and the evaluation of PR1010(x, ε−(TR1)) may also return a value of “TRUE”.

It should be noted that the above evaluations signify that TR101 would denote row x as satisfying predicate PR1010 both before and after the supposed commitment of TR1.

At S530, it is determined if the predicate returns a value of “TRUE” for both ε+ and ε−. For example, if PR1010(x, ε+(TR1)) and PR1010(x, ε−(TR1)) return a TRUE value. If the predicate does not return a value of “TRUE” for both instances, execution returns. If the predicate does return a value of “TRUE” for both instances, the process proceeds to S540.

At S540, the conditional conflict is classified as being in a stay-in state. It should be noted that this classification subsequently allows for process 400 not to mark dependencies related to the conditional conflict.

The procedure described in FIG. 5 may be further demonstrated by the following examples. According to one example, there are two transactions in a database that are executed, TR101 and TR1. The database includes a table with rows representing employees and each row contains a plurality of characteristics for its respective employee, including hair color, salary, and profession. Reading-transaction TR101 is a transaction that scans all the employees, and for each employee, TR101 reads the cells corresponding to the employee's hair color and profession and modifies the cell for that employee's salary if the employee has red or orange hair and is a software engineer. Within this example database, there exists an employee “Jane” who has orange hair and is a software engineer. As TR101 executes, it will therefore select “Jane”. TR1 is a transaction that modifies Jane's hair color to the color red. As TR1 executes concurrently, TR1 will modify the hair color of “Jane” from orange to red. According to S510, as TR1 validates, a conditional conflict will be detected between TR1 and the reading transaction TR101. According to S520, the epsilon checking procedure will be applied to the conflict. It should be noted that the predicate PR1010 of the reading transaction TR101 in this example will be the condition that an employee's hair be red or orange and that the employee be a software engineer.

According to this example, the predicate function PR1010(Jane, ε−(TR1)) will evaluate whether the predicate of TR101 will be satisfied by “Jane” at the moment before the commitment of transaction TR1. In this example, PR1010(Jane, ε−(TR1)) will return a value of “TRUE”. It should be noted that the values to be evaluated by the predicate function are those that are currently committed. The predicate function PR1010(Jane, ε+(TR1)) will evaluate whether the predicate of TR101 will be satisfied by “Jane” at the moment after the commitment of transaction TR1. In this example, PR1010(Jane, ε+(TR1)) will return a value of “TRUE”. It should be noted that the values to be evaluated by the predicate, for data cells that were not modified by TR1, are those that are currently committed. In addition, for data cells that were modified by TR1 the values to be evaluated by the predicate are those written by TR1. According to S530, since the evaluation of PR1010 returns a value of “TRUE” in both cases, the procedure will proceed to S540, and the conflict will be classified as being in a stay-in state. In an embodiment, when an early commitment is enabled by the epsilon checking, some procedures for ensuring the data-cell values used for the check will not be changed until TR1 commits are taken. In an embodiment, in some of those cases, if the data-cell values are changed, re-evaluation of the epsilon check may take place.

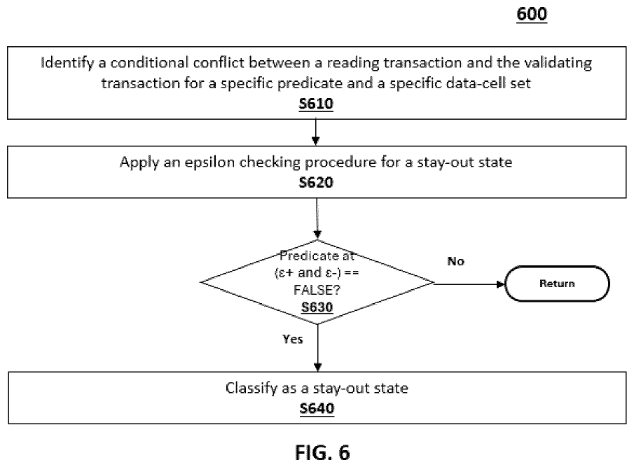

FIG. 6 is an example flowchart describing process 600 of classifying a conditional conflict as being in a stay-out state according to an embodiment. Process 600 may be performed as part of step S440, described within FIG. 4. At S610, a conditional conflict for a specific predicate and a specific data-cell set that the reading-transaction evaluated is identified. The conditional conflict is between a validating transaction and a reading-transaction, and the specific data-cell set includes, for example, the relevant data cells for the predicate evaluation in a specific row. According to an example embodiment, the validating transaction may be denoted as TR1, the reading transaction containing the predicate to be evaluated may be denoted as TR101, and the defined predicate may be denoted as PR1010. Additionally, according to the example embodiment, the predicate evaluates multiple rows of a table, so the identity of a row (e.g., row x) will be used to denote the associated data-cell set. It should be noted that according to the example embodiment, TR1 and TR101 run concurrently.

At S620, an epsilon checking procedure is applied to the identified conditional conflict. According to an embodiment, the epsilon checking procedure applies the epsilon principle to a current predicate being validated, e.g., PR1010, and a specific data-cell set. According to the example embodiment, the evaluation of PR1010(x, ε+(TR1)) may return a value of “FALSE” and the evaluation of PR1010(x, ε−(TR1)) may also return a value of “FALSE”. It should be noted that the above evaluations signify that TR101 would denote row x as not satisfying predicate PR1010 both before and after the supposed commitment of TR1.

At S630, the predicate (e.g., PR1010) is queried as to whether it returns a value of “FALSE” for both ε+ and ε−. For example, when applying the epsilon checking procedure on PR1010 it is determined if PR1010(x, ε+(TR1)) and PR1010(x, ε−(TR1)) return a FALSE value. If the predicate does not return a value of “FALSE” for both instances, execution returns. If the predicate does return a value of “FALSE” for both instances, the process proceeds to S640.

At S640, the conditional conflict is classified as being in a stay-out state. It should be noted that this classification subsequently allows for process 400 not to mark dependencies related to the conditional conflict.

The procedure described in FIG. 6 may be further demonstrated by the following example. In this example, there are two transactions in a database that are executed, TR101 and TR1. The database includes a table with rows representing employees, and each row contains a plurality of characteristics for each employee, including hair color, salary, and profession. Transaction TR101 is a reading-transaction that scans all the employees, and for each employee, TR101 reads the cells corresponding to the employee's hair color and profession and modifies the cell for that employee's salary if the employee has red or orange hair and is a software engineer. Within this example database, there exists an employee “Jane” who has blond hair and is a dentist. As TR101 executes, the transaction will therefore not select “Jane”. TR1 is a transaction that modifies Jane's hair color to the color red. As TR1 executes concurrently, it will modify the hair color of “Jane” from blond to red.

According to S610, as TR1 validates, a conditional conflict will be detected between TR1 and the reading-transaction TR101. According to S620, an epsilon checking procedure will be applied to the conflict. It should be noted that the predicate PR1010 of the reading-transaction TR101, in this example, will be the condition that an employee's hair be red or orange and that the employee be a software engineer. The predicate function PR1010(Jane, ε−(TR1)) will evaluate whether the predicate of TR101 will be satisfied by “Jane” at the moment before the commitment of transaction TR1.

In this example, PR1010(Jane, ε−(TR1)) will return a value of “FALSE” because Jane's hair color of blond does not satisfy the predicate. It should be noted that the values to be evaluated by the predicate function are those that are currently committed. The predicate function PR1010(Jane, ε+(TR1)) will evaluate whether the predicate of TR101 will be satisfied by “Jane” at the moment after the commitment of transaction TR1. In this example, PR1010(Jane, ε+(TR1)) will return a value of “FALSE” because Jane's profession as a dentist does not satisfy the predicate despite her hair color being red.

It should be noted that the values to be evaluated by the predicate, for data cells that were not modified by TR1, are those that are currently committed. In addition, for data cells that were modified by TR1 the values to be evaluated by the predicate are those written by TR1. According to S630, since the evaluation of PR1010 returns a value of “FALSE” in both cases, the procedure will proceed to S640, and the conflict will be classified as being in a stay-out state. In an embodiment, when early commitment is enabled by the epsilon checking, means for ensuring the data-cell values used for the check will not be changed until TR1 commits are taken. In an embodiment, in some of those cases, if the data-cell values are changed, re-evaluation of the epsilon check may take place.

An additional example embodiment below demonstrates how the procedure described by FIG. 6 may be applied to transactions that modify multiple cells. According to the embodiment, there are two transactions in a database that are executed, TR101 and TR1. The database includes a table with rows representing employees and each row contains a plurality of characteristics for its respective employee, including hair color, salary, and profession. TR101 is a transaction that scans all the employees, and for each employee, TR101 reads the cells corresponding to the employee's hair color, and profession and modifies the cell for that employee's salary if the employee has red or orange hair and is a software engineer. Within this example database, there exists an employee “Jane” who has blond hair and is a software engineer. According to this example, as TR101 executes, the transaction will, therefore, not select “Jane”. TR1 is a transaction that modifies Jane's hair color to red and modifies Jane's profession to “dentist”. As TR1 executes concurrently, it will modify the hair color of “Jane” from blond to red and the profession of “Jane” from software engineer to dentist.

According to S610, as TR1 validates, a conditional conflict will be detected between TR1 and the reading transaction TR101. According to S620, the epsilon checking procedure will be applied to the conflict. It should be noted that the predicate PR1010 of the reading-transaction TR101, in this example, will be the condition that an employee's hair be red or orange and that the employee be a software engineer. The predicate function PR1010(Jane, ε−(TR1)) will evaluate whether the predicate of TR101 will be satisfied by “Jane” at the moment before the commitment of transaction TR1. In this example, PR1010(Jane, ε−(TR1)) will return a value of “FALSE” because Jane's hair color of blond does not satisfy the predicate. It should be noted that the values to be evaluated by the predicate function are those that are currently committed. The predicate function PR1010(Jane, ε+(TR1)) will evaluate whether the predicate of TR101 will be satisfied by “Jane” at the moment after the commitment of transaction TR1. In this example, PR1010(Jane, ε+(TR1)) will return a value of “FALSE” because Jane's profession as a dentist does not satisfy the predicate despite her hair color being red.

It should be noted that the values to be evaluated by the predicate, for data cells that were not modified by TR1, are those that are currently committed. In addition, for data cells that were modified by TR1 the values to be evaluated by the predicate are those written by TR1. According to S630, since the evaluation of PR1010 returns a value of “FALSE” in both cases, the procedure will proceed to S640, and the conflict will be classified as being in a stay-out state.

A variation on the scenario above may demonstrate the importance of the single predicate evaluation consistency principle in an example scenario. In the example scenario, TR101 and TR1 perform the same functions as above on the same database, but TR101 does not follow the single predicate evaluation consistency principle. According to the example, TR101 may first start to evaluate Jane's predicate by reading Jane's profession, which returns the value of “software engineer”. Since TR101 does not follow the single predicate evaluation consistency principle, TR1 may then be allowed to commit before TR101 reads Jane's hair color. This may result in TR101 reading Jane's hair color after TR1's commit and returning a value of “red”. TR101 may then evaluate the predicate and return a value of “TRUE”, which may violate serializability and other expected consistency properties. It is, therefore, advantageous to avoid such violations by maintaining the single predicate evaluation consistency principle for all predicates evaluated as part of the predictive CCP.

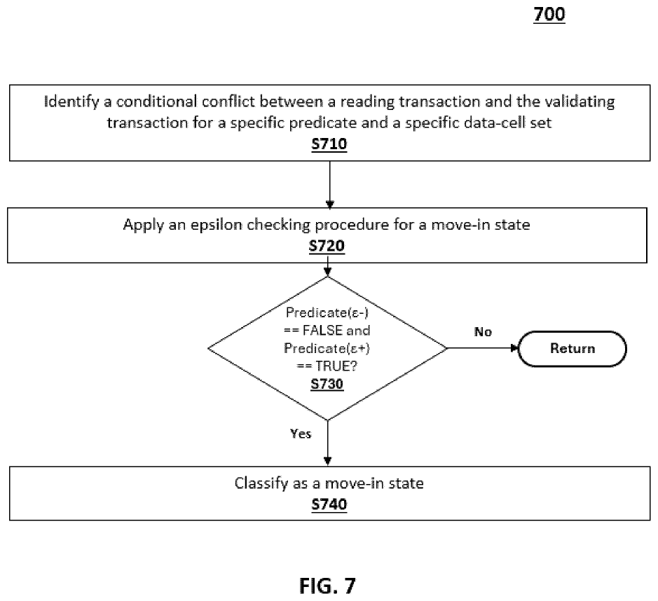

FIG. 7 is an example flowchart describing a process 700 of classifying a conditional conflict as being in a move-in state according to an embodiment. Process 700 may be performed as part of S440 described in FIG. 4. At S710, a conditional conflict for a specific predicate and a specific data-cell set that the reading-transaction evaluated is identified. The conditional conflict is between a validating transaction and a reading-transaction, and the specific data-cell set includes, for example, the relevant data cells for the predicate evaluation in a specific row. According to an example embodiment, the validating transaction may be denoted as TR1, the reading-transaction containing the predicate to be evaluated may be denoted as TR101, and the defined predicate may be denoted as PR1010. Additionally, according to the example embodiment, the predicate evaluates multiple rows of a table, so the identity of a row (e.g., row x) will be used to denote the associated data-cell set. It should be noted that according to the example embodiment, TR1 and TR101 run concurrently.

At S720, an epsilon checking procedure is applied to the identified conditional conflict. According to an embodiment, the epsilon checking procedure applies the epsilon principle to the predicate PR1010, and a specific data-cell set. According to the example embodiment, the evaluation of PR1010(x, ε+(TR1)) may return a value of “TRUE” and the evaluation of PR1010(x, ε−(TR1)) may return a value of “FALSE”. It should be noted that the above evaluations signify that TR101 would denote row ‘x’ as not satisfying predicate PR1010 before the commitment of TR1 and as satisfying predicate PR1010 after the commitment of TR1.

At S730, the predicate PR1010 is queried as to whether it returns a value of “TRUE” for a ε+ and a “FALSE” value for a ε−. That is, it is queried as to whether there is a result of “TRUE” for PR1010(x, ε+(TR1)) and “FALSE” for PR1010(x, ε−(TR1)). If the predicate does not satisfy these conditions, execution returns. If the predicate does satisfy these conditions, the process proceeds to S740.

At S740, the conditional conflict is classified as being in a move-in state. It should be noted that this classification subsequently allows for process 400 to mark dependencies related to the conditional conflict.

The procedure described by FIG. 7 may be further demonstrated by the following example embodiment. According to the embodiment, there are two transactions in a database that are executed, TR101 and TR1. The database includes a table with rows representing employees, and each row contains a plurality of characteristics for each employee, including hair color, salary, and profession. TR101 is a reading-transaction that scans all the employees, and for each employee, the reading-transaction TR101 reads the cells corresponding to the employee's hair color and profession, and modifies the cell for that employee's salary if the employee has red or orange hair and is a software engineer.

Within this example database, there exists an employee, “Jane,” who has blond hair and is a software engineer. As TR101 executes, the transaction will, therefore, not select “Jane”. TR1 is a transaction that modifies Jane's hair color to the color red. As TR1 executes concurrently, the transaction will modify the hair color of “Jane” from blond to red. According to S710, as TR1 validates, a conditional conflict will be detected between TR1 and the reading-transaction TR101. According to S720, an epsilon checking procedure will be applied to the conflict. It should be noted that the predicate PR1010 of the reading-transaction TR101 in this example embodiment will be the condition that an employee's hair be red or orange and that the employee be a software engineer. The predicate function PR1010(Jane, ε−(TR1)) will evaluate whether the predicate of TR101 will be satisfied by “Jane” at the moment before the commitment of transaction TR1. In this example, PR1010(Jane, ε−(TR1)) will return a value of “FALSE” because Jane's hair color of blond does not satisfy the predicate. It should be noted that the values to be evaluated by the predicate function are those that are currently committed. The predicate function PR1010(Jane, ε+(TR1)) will evaluate whether the predicate of TR101 will be satisfied by “Jane” at the moment after the commitment of transaction TR1.

In this example, PR1010(Jane, ε+(TR1)) will return a value of “TRUE” because Jane's new hair color of red, along with her profession as a software engineer, does satisfy the predicate. It should be noted that the values to be evaluated by the predicate, for data cells that were not modified by TR1, are those that are currently committed. In addition, for data cells that were modified by TR1 the values to be evaluated by the predicate are those written by TR1. According to S730, since the evaluation of PR1010 returns a value of “FALSE” for PR1010(Jane, ε−(TR1)) and a value of “TRUE” for PR1010(Jane, ε+(TR1)), the procedure will proceed to S740, and the conflict will be classified as being in a move-in state.

An additional example embodiment below demonstrates how the procedure described in FIG. 7 may be applied to transactions that modify multiple cells. According to the embodiment, there are two transactions in a database that are executed, TR101 and TR1. The database includes a table with rows representing employees, and each row contains a plurality of characteristics for each employee, including hair color, salary, and profession. TR101 is a reading transaction that scans all the employees, and for each employee, TR101 reads the cells corresponding to the employee's hair color, and profession and modifies the cell for that employee's salary if the employee has red or orange hair and is a software engineer. Within this example database, there exists an employee, “Jane”, who has blond hair and is a dentist. As TR101 executes, the transaction will, therefore, not select “Jane”. TR1 is a transaction that modifies Jane's hair color to the color red and modifies Jane's profession to “software engineer”. As TR1 executes concurrently, TR1 will modify the hair color of “Jane” from blond to red and change the profession of “Jane” to software engineer.

According to S710, as TR1 validates, a conditional conflict will be detected between TR1 and the reading-transaction TR101. According to S720, the epsilon checking procedure will be applied to the conflict. It should be noted that the predicate PR1010 of the reading-transaction TR101 in this example embodiment will be the condition that an employee's hair be red or orange and that the employee be a software engineer. The predicate function PR1010(Jane, ε−(TR1)) will evaluate whether the predicate of TR101 will be satisfied by “Jane” at the moment before the commitment of transaction TR1. In this example, PR1010(Jane, ε−(TR1)) will return a value of “FALSE” because Jane's hair color of blond, along with her profession of “dentist” does not satisfy the predicate. It should be noted that the values to be evaluated by the predicate function are those that are currently committed. The predicate function PR1010(Jane, ε+(TR1)) will evaluate whether the predicate of TR101 will be satisfied by “Jane” at the moment after the commitment of transaction TR1. In this example, PR1010(Jane, ε+(TR1)) will return a value of “TRUE” because Jane's new hair color of red, along with her new profession of software engineer, does satisfy the predicate. It should be noted that the values to be evaluated by the predicate, for data cells that were not modified by TR1, are those that are currently committed. In addition, for data cells that were modified by TR1 the values to be evaluated by the predicate are those written by TR1.

According to S730, since the evaluation of PR1010 returns a value of “FALSE” for PR1010(Jane, ε−(TR1)) and a value of “TRUE” for PR1010(Jane, ε+(TR1)), the procedure will proceed to S740, and the conflict will be classified as being in a move-in state.

A further example embodiment below demonstrates how the procedure described by FIG. 7 may be applied to multiple writing transactions. According to the embodiment, there are three transactions in a database that are executed, TR101, TR1, and TR2. The database includes a table with rows representing employees and each row contains a plurality of characteristics for its respective employee, including hair color, salary, and profession. Transaction TR101 is a reading-transaction that scans all the employees, and for each employee, TR101 reads the cells corresponding to the employee's hair color and profession, and modifies the cell for that employee's salary if the employee has red or orange hair and is a software engineer. Within this example database, there exists an employee, “Jane”, who has blond hair and is a dentist. As TR101 executes, the transaction will, therefore, not select “Jane”. TR1 is a transaction that modifies Jane's hair color to the color red. TR2 is a transaction that modifies Jane's profession to “software engineer”. As transaction TR1 executes concurrently, TR1 will modify the hair color of “Jane” from blond to red. Additionally, TR2 will also concurrently modify the profession of “Jane” to software engineer. The following two example scenarios demonstrate how principles of serializability and consistency may be maintained in embodiments involving multiple writing-transactions, regardless of the order of the writing-transactions.

In a first example scenario, TR1 will validate and commit before TR2. At the time of TR1's validation, it will evaluate the predicate PR1010 for the moments before and after the commitment of TR1. At the moment before the commitment of TR1, Jane's hair color will be blond, and Jane's profession will be “dentist”, resulting in the ε− evaluation returning “FALSE”. Likewise, at the moment after TR1, Jane's hair color will be red, and Jane's profession will be “dentist”, resulting in the ε+ evaluation returning “FALSE.”.

The epsilon principle will thus be satisfied, and TR1 will be allowed to commit earlier than TR101, while TR101 continues to execute. Jane's hair color will now be red, and Jane's profession will be “dentist”. Next, TR2 will validate. TR2 will evaluate PR1010 for the moments before and after TR2's commitment. At the moment before TR2's commitment, Jane's hair color will be red, and Jane's profession will be “dentist”, resulting in the ε− evaluation returning “FALSE”. However, at the moment after TR2's commitment, Jane's hair color will be red, and Jane's profession will be “software engineer”, resulting in the ε+ evaluation returning “TRUE”. This violates the epsilon principle, creating a moving-in scenario, and TR2 will not be allowed to commit early and will be made dependent on TR101. After TR101 completes its execution, TR2 will then commit and change Jane's profession to software engineer. It should be noted that in this scenario, TR1 may be allowed to commit early because TR101 would not select Jane regardless of whether Jane's hair color was blond or red. It should also be noted that if TR1 did not exist, a moving-in scenario would not occur for TR2's validation, and TR2 would be allowed to commit early.

In a second example scenario, TR2 will validate and commit before TR1. At the time of TR2's validation, it will evaluate the predicate PR1010 for the moments before and after the commitment of TR2. At the moment before TR2's commitment, Jane's hair color will be blond, and Jane's profession will be “dentist”, resulting in the ε− evaluation returning “FALSE”. Likewise, at the moment after TR2's commitment, Jane's hair color will be blond, and Jane's profession will be “software engineer”, resulting in the ε+ evaluation returning “FALSE”. The epsilon principle applied by the procedure will thus be satisfied, and TR2 will be allowed to commit earlier than TR101, while TR101 continues to execute. Jane's hair color will now be blond, and Jane's profession will be “software engineer”. Next, TR1 will validate. TR1 will evaluate PR1010 for the moments before and after TR1's commitment. At the moment before TR1's commitment, Jane's hair color will be blond, and Jane's profession will be “software engineer”, resulting in the ε− evaluation returning “FALSE”. However, at the moment after TR1's commitment, Jane's hair color will be red and Jane's profession will be “software engineer”, resulting in the ε+ evaluation returning “TRUE”. This violates the epsilon principle, creating a moving-in scenario, and TR1 will not be allowed to commit early and will be made dependent on TR101. After TR101 completes its execution, TR1 will then commit and change Jane's profession to software engineer. It should be noted that in this scenario, TR2 may be allowed to commit early because TR101 would not select Jane regardless of whether Jane's profession was “dentist” or “software engineer”. It should also be noted that if TR2 did not exist, a moving-in scenario would not occur for TR1's validation, and TR1 would be allowed to commit early.

It should be noted that in the example embodiment above, principles of serializability and consistency may be violated by the presence of a race condition among TR1 and TR2's validations. A race condition may be described as a condition that allows for one of the transactions, TR1 and TR2, to proceed to validate prior to the commitment of the other transaction. The following scenario demonstrates how a race condition may lead to a result that violates serializability and consistency principles.

In an example scenario, TR1 proceeds to validate before TR2. An evaluation of the epsilon principle as applied to PR1010 will result in the determination that the epsilon principle is satisfied, as demonstrated in the first of the example scenarios above. TR1 will be allowed to commit early. However, in the time between TR1's validation and commitment, a race condition may allow TR2 to proceed with its own validation. TR1 will not have yet committed, and thus, the currently committed cell contents that TR2 reads will be the same as those that TR1 has read. These cell contents will include the fact that Jane's employee's hair color is blond and that Jane's profession is “dentist”. TR2 will conduct its own evaluation of the epsilon principle as applied to PR1010, which will result in the determination that the epsilon principle is satisfied, as demonstrated in the second of the example scenarios above.

TR2 will then be enabled to commit early. Since both TR1 and TR2 are allowed to commit early, their respective modifications will be committed prior to the commitment of TR101. These committed modifications will result in Jane's hair color being red and Jane's profession being “software engineer”, creating an unrecognized moving-in scenario in contradiction to the cell contents that were initially read by TR101. This would thus result in a violation of serializability and consistency principles. It should be noted that the potential for such violations caused by race conditions in certain embodiments may be mitigated by a guaranteeing mechanism that blocks TR's validation until after TR1's commitment.

In an embodiment, when early commitment is enabled by the epsilon checking, means for ensuring the data-cell values used for the check will not be changed until the validating transaction commits are taken. In an embodiment, in some of those cases, if the data-cell values are changed, detection and re-evaluation of the epsilon check may take place.

A further example embodiment below demonstrates how the presence of multiple writing-transactions may allow for a first writing-transaction to commit early based on committed cell-content values established by the commitment of a second writing-transaction subsequent to the first writing-transaction. According to the embodiment, there are three transactions in a database that are executed, TR101, TR1, and TR2. The database includes a table with rows representing employees and each row contains a plurality of characteristics for its respective employee, including hair color, salary, and profession. TR101 is a reading-transaction that scans all the employees, and for each employee, TR101 reads the cells corresponding to the employee's hair color and profession, and modifies the cell for that employee's salary if the employee has red or orange hair and is a software engineer. Within this example database, there exists an employee, “Jane”, who has blond hair and is a software engineer. As TR101 executes, the transaction will, therefore, not select “Jane”. TR1 is a transaction that modifies Jane's hair color to the color red. TR2 is a transaction that modifies Jane's profession to “dentist”. As TR1 executes concurrently, TR1 will modify the hair color of “Jane” from blond to red. Additionally, TR2 will also concurrently modify the profession of “Jane” to “dentist”.

In an example scenario, TR1 will start to validate before TR2. At the time of TR1's validation, it will evaluate the predicate PR1010 for the moments before and after TR1's commitment. At the moment before TR1's commitment, Jane's hair color will be blond and Jane's profession will be “software engineer”, resulting in the ε− evaluation returning “FALSE”. However, at the moment after TR1's commitment, Jane's hair color will be red and Jane's profession will be “software engineer”, resulting in the ε+ evaluation returning “TRUE”. The epsilon principle will thus be violated and TR1 will be placed as dependent on the commitment of TR101. Jane's hair color will remain blond. Next, TR2 will validate. TR2 will evaluate PR1010 for the moments before and after TR2's commitment. At the moment before TR2's commitment, Jane's hair color will be blond and Jane's profession will be “software engineer”, resulting in the ε− evaluation returning “FALSE”. Likewise, at the moment after TR2's commitment, Jane's hair color will be blond and Jane's profession will be “dentist”, resulting in the ε+ evaluation returning “FALSE”. This satisfies the epsilon principle, creating a staying-out scenario, and TR2 will be allowed to commit earlier than TR101, while TR101 is still executing. After TR2 commits early and before TR101 commits, according to an embodiment, TR1 may re-validate by evaluating PR1010, this time using the cell contents after the commitment of transaction TR2. At the moment before TR1's commitment, Jane's hair color will be blond and Jane's profession will be “dentist”, resulting in the ε− evaluation returning “FALSE”. At the moment after TR1's commitment, Jane's hair color will be red and Jane's profession will be “dentist”, resulting in the ε+ evaluation returning “FALSE”. This creates a staying-out scenario, and the epsilon principle will be satisfied. TR1 will then be allowed to commit earlier than TR101, while TR101 is still executing. Thus, the presence of TR2 in this scenario will enable TR1 to commit earlier than transaction TR101 after TR1 had been previously determined to be dependent on TR101. It should be noted that even if TR1 were to remain dependent on TR101 and did not commit early, correctness would not be hurt. The above scenario demonstrates an opportunity to increase concurrency further and hence increase performance.

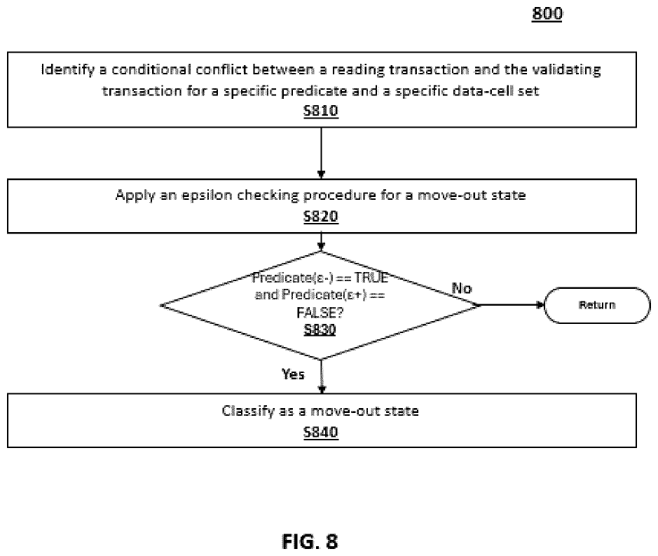

FIG. 8 is an example flowchart describing a process 800 of classifying a conditional conflict as being in a move-out state according to an embodiment. Process 800 may be performed as part of step S440 described within FIG. 4. At S810, a conditional conflict for a specific predicate and a specific data-cell set that the reading-transaction evaluated is identified. The conditional conflict is between a validating transaction and a reading-transaction, and the specific data-cell set includes, for example, the relevant data cells for the predicate evaluation in a specific row. According to an example embodiment, the validating transaction may be denoted as TR1, the reading transaction containing the predicate to be evaluated may be denoted as TR101, and the defined predicate may be denoted as PR1010. Additionally, according to the example embodiment, the predicate evaluates multiple rows of a table, so the identity of a row (e.g., row x) will be used to denote the associated data-cell set. It should be noted that according to the example embodiment, TR1 and TR101 run concurrently.

At S820, an epsilon checking procedure is applied to the identified conditional conflict. According to an embodiment, the epsilon checking procedure applies the epsilon principle to the predicate PR1010, and a specific data-cell set. According to the example embodiment, the evaluation of the predicate at ε+ would result in a “FALSE” value, and ε− would result in a “TRUE” value. That is, PR1010(x, ε+(TR1)) would return a value of “FALSE” and the evaluation of PR1010(x, ε−(TR1)) would return a value of “TRUE”. It should be noted that the above evaluations signify that TR101 would denote row x as satisfying predicate PR1010 before the commitment of TR1 and as not satisfying predicate PR1010 after the commitment of TR1.

At S830, the predicate PR1010 is queried as to whether it returns a value of “FALSE” for PR1010(x, ε+(TR1)) and “TRUE” for PR1010(x, ε−(TR1)). If the predicate does not satisfy these conditions, execution returns. If the predicate does satisfy these conditions, the process proceeds to S840.

At S840, the conditional conflict is classified as being in a move-out state. It should be noted that this classification subsequently allows for process 400 to mark dependencies related to the conditional conflict.

The procedure described in FIG. 8 may be further demonstrated by the following example. According to this example, two transactions in a database are executed: TR101 and TR1. The database includes a table with rows representing employees and each row contains a plurality of characteristics for its respective employee, including hair color, salary, and profession. Transaction TR101 is a reading-transaction that scans all the employees, and for each employee, TR101 reads the cells corresponding to the employee's hair color and profession, and modifies the cell for that employee's salary if the employee has red or orange hair and is a software engineer. Within this example database, there exists an employee, “Jane”, who has orange hair and is a software engineer. As TR101 executes, it will therefore select “Jane”. Transaction TR1 is a transaction that modifies Jane's hair color to the color black. As TR1 executes concurrently, it will modify the hair color of “Jane” from orange to black.

According to S810, as TR1 validates, a conditional conflict will be detected between TR1 and the reading transaction TR101. According to S820, an epsilon checking procedure will be applied to the conflict. It should be noted that the predicate PR1010 of the reading transaction TR101 in this example embodiment will be the condition that an employee's hair be red or orange and that the employee be a software engineer. The predicate function PR1010(Jane, ε−(TR1)) will evaluate whether the predicate of TR101 will be satisfied by “Jane” at the moment before the commitment of transaction TR1. In this example, PR1010(Jane, ε−(TR1)) will return a value of “TRUE” because Jane's hair color is orange, and the profession of software engineer satisfies the predicate.

It should be noted that the values to be evaluated by the predicate function are those that are currently committed. The predicate function PR1010(Jane, ε+(TR1)) will evaluate whether the predicate of TR101 will be satisfied by “Jane” at the moment after the commitment of transaction TR1. In this example, PR1010(Jane, ε+(TR1)) will return a value of “FALSE” because Jane's new hair color of black does not satisfy the predicate. It should be noted that the values to be evaluated by the predicate, for data cells that were not modified by TR1, are those that are currently committed. In addition, for data cells that were modified by TR1 the values to be evaluated by the predicate are those written by TR1. According to S830, since the evaluation of PR1010 returns a value of “TRUE” for PR1010(Jane, ε−(TR1)) and a value of “FALSE” for PR1010(Jane, ε+(TR1)), the procedure will proceed to S840, and the conflict will be classified as being in a move-out state.

An additional example embodiment below demonstrates how the procedure described by FIG. 8 may be applied to transactions that modify multiple cells. According to the embodiment, there are two transactions in a database that are executed, TR101 and TR1. The database includes a table with rows representing employees and each row contains a plurality of characteristics for its respective employee, including hair color, salary, and profession. TR101 is a reading-transaction that scans all the employees, and for each employee, TR101 reads the cells corresponding to the employee's hair color and profession, and modifies the cell for that employee's salary if the employee has red or orange hair and is a software engineer. Within this example database, there exists an employee, “Jane”, who has orange hair and is a software engineer. As TR101 executes, it will therefore select “Jane”.

TR1 is a transaction that modifies Jane's hair color to the color black and modifies Jane's profession to “dentist”. As TR1 executes concurrently, TR1 will modify the hair color of “Jane” from orange to black and modify the profession of “Jane” to the dentist. According to S810, as TR1 validates, a conditional conflict will be detected between TR1 and the reading-transaction TR101. According to S820, an epsilon checking procedure will be applied to the conflict. It should be noted that the predicate of the reading-transaction TR101 in this example embodiment will be the condition that an employee's hair be red or orange and that the employee be a software engineer.

The predicate function PR1010(Jane, ε−(TR1)) will evaluate whether the predicate of TR101 will be satisfied by “Jane” at the moment before the commitment of transaction TR1. In this example, PR1010(Jane, ε−(TR1)) will return a value of “TRUE” because Jane's hair color is orange, and the profession of software engineer satisfies the predicate. It should be noted that the values to be evaluated by the predicate function are those that are currently committed. The predicate function PR1010(Jane, ε+(TR1)) will evaluate whether the predicate of TR101 will be satisfied by “Jane” at the moment after the commitment of transaction TR1.

In this example, PR1010(Jane, ε+(TR1)) will return a value of “FALSE” because Jane's new hair color is black, along with her new profession of “dentist” does not satisfy the predicate. It should be noted that the values to be evaluated by the predicate, for data cells that were not modified by TR1, are those that are currently committed. In addition, for data cells that were modified by TR1 the values to be evaluated by the predicate are those written by TR1. According to S830, since the evaluation of PR1010 returns a value of “TRUE” for PR1010(Jane, ε−(TR1)) and a value of “FALSE” for PR1010(Jane, ε+(TR1)), the procedure will proceed to S840, and the conflict will be classified as being in a move-out state.

It should be noted that certain transactions involving referenced self-writes may cause inconsistencies when the procedures described above are applied and thus may require modifications to the procedures. According to the present disclosure, a referenced self-write is a writing operation performed by a reading-transaction, for example, TR101, to a data cell that TR101 will later on read as part of a predicate evaluation. A referenced self-write may interfere with the procedures described above by remaining undetected and unread by a validating transaction, for example, TR1, possibly resulting in an incorrect determination that TR1 is able to commit early.

The inconsistencies that may be created by the presence of a referenced self-write may be demonstrated by the following example. According to this example, two transactions in a database are executed: TR101 and TR1. The database includes a table with rows representing employees and each row contains a plurality of characteristics for its respective employee, including hair color, salary, and profession. Within this example database, there exists an employee, “Jane”, who has blond hair and is a dentist. TR101 is a reading-transaction that first modifies Jane's hair color to “red”. Then, transaction TR101 scans all the employees, and for each employee, TR101 reads the cells corresponding to the employee's hair color and profession and then modifies the cell for that employee's salary if the employee has red or orange hair and is a software engineer, conditions which may be denoted as predicate PR1010. TR1 is a transaction that modifies Jane's profession to “software engineer”. As TR101 executes, it will first modify “Jane's” hair color from blond to red. This modification is the referenced self-write.

It should be noted that, as part of the predictive CCP that guarantees serializability and other expected consistency properties, such a modification is done in an uncommitted manner and hence is not generally visible to other transactions. However, for the sake of serializability and other expected consistency properties, such a modification should be visible to the reading-transaction TR101 itself, if it later on reads the pertinent modified data cell. That is, if TR101, later on, reads Jane's hair color, the content it should read would be “red”. Transaction TR101 will then read on the currently committed cells with the addition of any self-written modifications. Transaction TR101 will thus read on the cells as if employee “Jane” has red hair and is a dentist. Note that prior to scanning the employees and evaluating the predicate PR1010 on each, TR101 adds a conditional RV-entry describing PR1010's evaluation.

According to the procedures described above, the cells that are read by TR101 will be inconsistent with the cells assumed to be read by TR101 from the logic of the validating transaction TR1, as TR1 would not recognize the modification of “Jane's” hair color to red by TR101. Instead, TR1 would assume that “Jane's” hair color remains blond. As TR1 executes concurrently with TR101, it will modify “Jane's” profession to “software engineer” and add the modified row to its WV. The epsilon checking procedure will then be applied to the conditional conflict detected between TR1 and TR101. The predicate of TR101, PR1010, will be evaluated for both the ε− and ε+ conditions as applied to TR1. In other words, PR1010(Jane, ε−(TR1)) and PR1010(Jane, ε+(TR1)) will be evaluated. With regards to PR1010(Jane, ε−(TR1)), it will be determined that from the perspective of TR1, at the moment before the commitment of TR1, the predicate evaluation will return a value of “FALSE” since “Jane's” hair color is assumed to be blond. With regards to PR1010(Jane, ε+(TR1)), it will be determined that from the perspective of TR1, at the moment after the commitment of TR1, the predicate evaluation will return a value of “FALSE” since “Jane's” hair color is assumed to remain blond. TR1 will thus proceed to early commitment, as the state of the conflict is classified as a stay-out state. However, this would be inconsistent with the perspective of TR101 that “Jane's” hair color is red at the time of the evaluation of PR1010. In this example, the inconsistency may result in an unrecognized moving-in state created by the committed modification by TR1 and the referenced self-write by TR101. The inconsistency may further result in a violation of serializability and other consistency expectations.

Therefore, the inconsistencies created by the presence of referenced self-writes necessitate a modification of the aforementioned procedures. A possible modification targeting the epsilon checking procedure can be described as follows. Taking the example described above, in order to align the cell contents read by TR101 with the cell contents read by TR1, the epsilon checking procedure applied to TR1 should take into account any modifications made by TR101 prior to the evaluation of PR1010. Additionally, in some embodiments, there would not be any modification of data cells from the moment that a conditional RV-entry for PR1010 is created until the moment that PR1010 is evaluated.

According to the present disclosure, the solution to the inconsistencies created by referenced self-writes may involve the creation of a trail of ordered data-access operations. Such operations may include the creation of both RV entries and WV entries. The trail of operations may be facilitated by an Intra-Transaction Data-Access Trail Order-ID (ITDAT Order-ID) and may increase monotonously according to a real-clock timestamp, a logical timestamp (such as a counter), and the like. In an embodiment, when created, WV-entries and RV-entries are each assigned an ITDAT Order-ID such that those ITDAT Order-ID values are unique and monotonously increasing.

As applied to the example described above, the creation of an RV entry by TR101, and the creation of a WV entry by TR101 would all be assigned an ITDAT Order-ID. It should be noted that the creation of a WV entry by TR1 would also result in assigning an ITDAT Order-ID, although that fact will not be used by the following description. An amended epsilon procedure may be applied to TR1 and TR101 as follows. According to the amended epsilon checking procedure, the evaluation of a predicate PR1010 for ε−(TR1) would read on the currently committed contents of the relevant data cells, modified by any write operations by TR101 for the data cells, up to the moment of TR101's conditional RV-entry, where the write operations modify the data cells in the order denoted by their respective ITDAT Order-IDs. Similarly, the evaluation for ε+(TR1) would read on the currently committed contents of the relevant data cells, modified by any write operations by TR1, and further modified by any write operations by TR101 for the data cells, up to the moment of TR101's conditional RV-entry, where the write operations by TR101 modify the data cells in the order denoted by their respective ITDAT Order-IDs. Utilizing this amended epsilon checking procedure, the presence of referenced self-writes may not result in an inconsistency of cell-content reads as between TR101 and TR1, and principles of serializability and consistency expectations may be preserved.

It should be noted that the amended epsilon checking procedure using ITDAT Order-IDs is merely one method for identifying and accommodating referenced self-writes. Any alternative method for accommodating referenced self-writes may be compatible with the present disclosure. For example, any alternative method that uses the ordering of RV and WV entries that do not utilize ITDAT Order-IDs may be compatible with the present disclosure.

The predictive CCP disclosed herein supports database operations performed on data rows. Such operations include inserting a row, deleting a row, and modifying a row. These operations are performed while maintaining the serializability and concurrency execution of transactions.

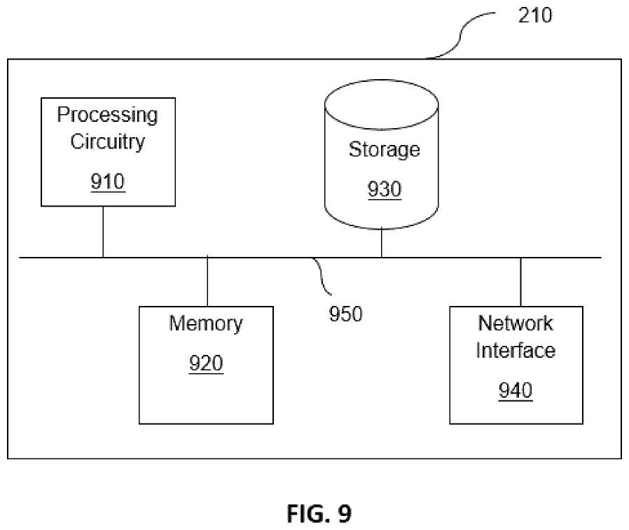

FIG. 9 is an example schematic diagram of a hardware layer of node 210 in a database 120 according to an embodiment. The node 210 includes a processing circuitry 910 coupled to a memory 920, a storage 930, and a network interface 940. In an embodiment, the components of the node 210 may be communicatively connected via a bus 950.

The processing circuitry 910 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 920 may be volatile (e.g., random access memory, etc.), non-volatile (e.g., read-only memory, flash memory, etc.), or a combination thereof.

In one configuration, software for implementing one or more embodiments disclosed herein may be stored in the storage 930. In another configuration, the memory 920 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 910, cause the processing circuitry 910 to perform the various processes described herein.

The storage 930 may be magnetic storage, optical storage, and the like, and may be realized, for example, as flash memory or other memory technology, compact disk-read-only memory (CD-ROM), Digital Versatile Disks (DVDs), or any other medium which can be used to store the desired information.

The network interface 940 allows the node to communicate with, for example, other nodes or with a transaction manager. It should be understood that the embodiments described herein are not limited to the specific architecture illustrated in FIG. 9, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to and executed by a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program or any combination thereof, which may be executed by a CPU, whether such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for managing the execution of database transactions in a database system, comprising:
during a validation phase of a transaction, identifying conditional conflicts and their corresponding conflicting transactions, wherein the corresponding conflicting transactions are reading-transactions conflicting with the transaction;
for each conditional conflict, classifying its state to determine if the transaction can commit, with respect to the conditional conflict, before the corresponding conflicting transaction;
marking the transaction as dependent on the corresponding conflicting transaction when the transaction cannot commit before the corresponding conflicting transaction; and
placing a commit pause on data cells modified by the transaction, thereby allowing the transaction to commit, when the transaction can commit before any corresponding conflicting transactions.

2. The method of claim 1, further comprising:
identifying non-conditional conflicts and their related conflicting transactions; and
for each non-conditional conflict, marking the transaction as dependent on the corresponding conflicting transaction.

3. The method of claim 2, further comprising:
waiting until all dependencies are cleared; and
placing a commit pause on data cells modified by the transaction.

4. The method of claim 1, wherein a conditional conflict is determined based, in part, on at least one predicate in the corresponding conflicting transaction.

5. The method of claim 4, wherein the state is determined based on the value of each of the least one predicates after applying an epsilon checking procedure, wherein the epsilon checking procedure evaluates values of a predicate on a data cell set immediately before and immediately after committing the transaction.

6. The method of claim 5, wherein a state of a conditional conflict is determined as a stay-in state when the evaluated values of a predicate immediately before and immediately after committing the transaction are a Boolean value true.

7. The method of claim 6, wherein the stay-in state provides that there is no potential dependency between the transaction and the corresponding conflicting transaction with respect to the conditional conflict.

8. The method of claim 5, wherein a state of a conditional conflict is determined as a stay-out state when the evaluated values of a predicate immediately before and immediately after committing the transaction are a Boolean value false.

9. The method of claim 8, wherein the stay-out state provides that there is no potential dependency between the transaction and the corresponding conflicting transaction with respect to the conditional conflict.

10. The method of claim 5, wherein a state of a conditional conflict is determined as a move-in state when the evaluated value of a predicate immediately before committing the transaction is a Boolean value false, and the evaluated value of the predicate immediately after committing the transaction is a Boolean value true.

11. The method of claim 10, wherein the move-in state does not allow the transaction to commit before the corresponding conflicting transaction.

12. The method of claim 5, wherein a state of a conditional conflict is determined as a move-out state when the evaluated value of a predicate immediately before committing the transaction is a Boolean value true, and the evaluated value of the predicate immediately after committing the transaction is a Boolean value false.

13. The method of claim 12, wherein the move-out state does not allow the transaction to commit before the corresponding conflicting transaction.

14. The method of claim 1, wherein tasks in the transaction are executed in an optimistic manner, wherein the transaction is validated in a pessimistic manner.

15. A method for managing the execution of database transactions, comprising:
receiving at least one statement that is a part of a transaction, wherein the transaction is initiated by a client to be executed on a database system;
executing tasks included in each of the at least one received statements in an optimistic manner, wherein the received at least one statement is not a commit statement;
upon receiving a commit statement, validating the transaction in a predictive and pessimistic manner to determine if the transaction can be committed before any conflicting transaction; and
returning to the client an acknowledgment that the transaction is committed, where the transaction is not dependent on any conflicting transaction.

16. The method of claim 1, wherein the conflicting transaction is determined to be any one of: a conditional conflict and a non-conditional conflict.

17. A non-transitory computer-readable medium storing a set of instructions for managing the execution of database transactions in a database system, the set of instructions comprising:
one or more instructions that, when executed by one or more processors of a device, cause the device to:
during a validation phase of a transaction, identifying conditional conflicts and their corresponding conflicting transactions, wherein the corresponding conflicting transactions are reading-transactions conflicting with the transaction;
for each conditional conflict, classify its state to determine if the transaction can commit, with respect to the conditional conflict, before the corresponding conflicting transaction;
mark the transaction as dependent on the corresponding conflicting transaction when the transaction cannot commit before the corresponding conflicting transaction; and
place a commit pause on data cells modified by the transaction, thereby allowing the transaction to commit, when the transaction can commit before any corresponding conflicting transactions.

18. A system for managing the execution of database transactions in a database system comprising:
one or more processors configured to:
during a validation phase of a transaction, identifying conditional conflicts and their corresponding conflicting transactions, wherein the corresponding conflicting transactions are reading-transactions conflicting with the transaction;
for each conditional conflict, classify its state to determine if the transaction can commit, with respect to the conditional conflict, before the corresponding conflicting transaction;
mark the transaction as dependent on the corresponding conflicting transaction when the transaction cannot commit before the corresponding conflicting transaction; and
place a commit pause on data cells modified by the transaction, thereby allowing the transaction to commit, when the transaction can commit before any corresponding conflicting transactions.

19. The system of claim 18, wherein the one or more processors are further configured to:
identify non-conditional conflicts and their related conflicting transactions; and
for each non-conditional conflict, mark the transaction as dependent on the corresponding conflicting transaction.

20. The system of claim 19, wherein the one or more processors are further configured to:
wait until all dependencies are cleared; and
place a commit pause on data cells modified by the transaction.

21. The system of claim 18, wherein a conditional conflict is determined based, in part, on at least one predicate in the corresponding conflicting transaction.

22. The system of claim 21, wherein the state is determined based on the value of each of the least one predicates after applying an epsilon checking procedure, the epsilon checking procedure evaluates values of a predicate on a data cell set immediately before and immediately after committing the transaction.

23. The system of claim 22, wherein a state of a conditional conflict is determined as a stay-in state when the evaluated values of a predicate immediately before and immediately after committing the transaction are Boolean value true.

24. The system of claim 23, wherein the stay-in state provides that there is no potential dependency between the transaction and the corresponding conflicting transaction with respect to the conditional conflict.

25. The system of claim 22, wherein a state of a conditional conflict is determined as a stay-out state when the evaluated values of a predicate immediately before and immediately after committing the transaction are Boolean value false.

26. The system of claim 25, wherein the stay-out state provides that there is no potential dependency between the transaction and the corresponding conflicting transaction with respect to the conditional conflict.

27. The system of claim 22, wherein a state of a conditional conflict is determined as a move-in state when the evaluated value of a predicate immediately before committing the transaction is a Boolean value false, and the evaluated value of the predicate immediately after committing the transaction is a Boolean value true.

28. The system of claim 27, wherein the move-in state does not allow the transaction to commit before the corresponding conflicting transaction.

29. The system of claim 22, wherein a state of a conditional conflict is determined as a move-out state when the evaluated value of a predicate immediately before committing the transaction is a Boolean value true, and the evaluated value of the predicate immediately after committing the transaction is a Boolean value false.

30. The system of claim 29, wherein the move-out state does not allow the transaction to commit before the corresponding conflicting transaction.

31. The system of claim 18, wherein tasks in the transaction are executed in an optimistic manner, the transaction is validated in a pessimistic manner.

32. The system of claim 18, wherein the conflicting transaction is determined to be any one of:
a conditional conflict and a non-conditional conflict.

33. A database system, comprising:
a plurality of nodes, wherein each of the plurality of nodes include:
a storage; and
one or more processors, wherein the one or more processors configured to:
receive at least one statement that is a part of a transaction, wherein the transaction is initiated by a client to be executed on a database system;
execute tasks included in each of the at least one received statements in an optimistic manner, wherein the received at least one statement is not a commit statement;
upon receiving a commit statement, validate the transaction in a predictive and pessimistic manner to determine if the transaction can be committed before any conflicting transaction; and
return to the client an acknowledgment that the transaction is committed, where the transaction is not dependent on any conflicting transaction.
